(19) United States
(12) Patent Application Publication
(10) Pub. No.: US 2009/0027625 A1
(43) Pub. Date: Jan. 29, 2009

(54) Image Projection Apparatus and a Light Source Module Thereof

(75) Inventors: Chui-Ping Chen, Hsinchu (TW); Sze-Ke Wang, Hsinchu (TW)

Correspondence Address: BANNER & WITCOFF, LTD., 1100 13th STREET, N.W., SUITE 1200, WASHINGTON, DC, 20005-4051, US

(73) Assignee: CORETRONIC CORPORATION, Hsinchu (TW)

(21) Appl. No.: 12/037,360

(22) Filed: Feb. 26, 2008

(30) Foreign Application Priority Data
Jul. 27, 2007 (TW) 096127528

(51) Int. Cl. G03B 21/28

(52) U.S. Cl. 353/31; 353/30

(57) ABSTRACT

An image projection apparatus includes a light source module, a lens unit, a light valve, and a projection lens. The light source module includes at least one laser array, at least one reflecting unit, a diffusing member, and a light uniformizing unit. The laser array includes a plurality of laser units that are arranged in a matrix. The reflecting unit has a plurality of reflecting surfaces that are non-parallel to each other, and that are disposed to receive and reflect laser beams emitted by the laser units. The diffusing member is disposed to receive and diffuse the laser beams reflected from the reflecting surfaces so as to form an illumination beam. The light uniformizing unit is disposed to receive and uniformize the illumination beam from the diffusing member.

### CROSS-REFERENCE TO RELATED APPLICATION

This application claims priority of Taiwanese Application No. 096127528, filed on Jul. 27, 2007.

### BACKGROUND OF THE INVENTION

1. Field of the Invention

The invention relates to an image projection apparatus, more particularly to an image projection apparatus that utilizes a laser array as a light source thereof.

2. Description of the Related Art

As compared with a conventional light source that is utilized in an image projection apparatus such as a halogen lamp or an ultra high pressure mercury lamp, a laser emits light beams with higher color purity, thereby enabling image projection devices using laser light sources to present better color reproduction. As shown in FIG. 1, a conventional image projection apparatus includes a laser diode array 11, a condenser 12, an integration rod 13, a lens unit 14, a light valve 15, and a projection lens 16. The laser diode array 11 has a plurality of laser diodes that emit light beams. The condenser 12 directs the light beams from the laser diode array 11 into the integration rod 13, which subsequently uniformizes the light beams. The light valve 15 receives uniformized light beams from the integration rod 13 through the lens unit 14 which adjusts the size of the light beams [d1]. The light valve 15 modulates the light beams received thereby so as to produce an image light beam, which is projected onto a screen 17 by the projection lens 16.

However, since the light beams emitted by laser diodes are inherently highly collimated, even after the light beams have been reflected multiple times in the integration rod 13, it is still difficult for the light beams outputted from the integration rod 13 to have a uniform intensity distribution. One of the ways to overcome this problem is to increase the length of the integration rod 13 so as to increase the number of times the light beams are reflected therein. However, as the integration rod 13 increases in length, the overall size of the conventional image projection apparatus increases accordingly.

In addition, since the light beams emitted by laser diodes are inherently highly coherent, speckles are formed on surfaces upon which the light beams are incident, thereby adversely affecting the image quality of the image light beam produced by the light valve 15.

### SUMMARY OF THE INVENTION

Therefore, an embodiment of the present invention is to provide an image projection apparatus with better image quality, and a light source module to be incorporated in an image projection apparatus and capable of improving the image quality of the image projection apparatus.

In order to achieve one or some or all of the above-mentioned objects or other objects, according to one aspect of the present invention, an image projection apparatus is provided and includes at least one laser array, at least one reflecting unit, a diffusing member, a light uniformizing unit, a lens unit, a light valve, and a projection lens. The laser array includes a plurality of laser units that are arranged in a matrix. Each of the laser units emits a laser beam. The reflecting unit has a plurality of reflecting surfaces that are non-parallel to each other, and that are disposed to receive and reflect the laser beams emitted by the laser units. The diffusing member is disposed to receive and diffuse the laser beams reflected from the reflecting surfaces of the at least one reflecting unit so as to form an illumination beam. The light uniformizing unit is disposed to receive and uniformize the illumination beam from the diffusing member. The lens unit is disposed to receive the illumination beam from the light uniformizing unit for adjusting a cross-sectional area of the illumination beam. The light valve is disposed to receive and modulate the adjusted illumination beam from the lens unit so as to form an image light beam. The projection lens is disposed to project the image light beam from the light valve onto a screen so as to form an image.

According to another aspect of the present invention, a light source module is provided. The light source module is adapted for use in an image projection apparatus, and includes at least one laser array, at least one reflecting unit, a diffusing member, and a light uniformizing unit. The laser array includes a plurality of laser units that are arranged in a matrix. Each of the laser units emits a laser beam. The reflecting unit has a plurality of reflecting surfaces that are non-parallel to each other, and that are disposed to receive and reflect the laser beams emitted by the laser units. The diffusing member is disposed to receive and diffuse the laser beams reflected from the reflecting surfaces of the at least one reflecting unit so as to form an illumination beam. The light uniformizing unit is disposed to receive and uniformize the illumination beam from the diffusing member.

By diffusing the laser beams reflected by the reflecting surfaces so as to form the illumination beam prior to entering the light uniformizing unit, it is ensured that the illumination beam exiting from the light uniformizing unit has a uniform intensity distribution. This not only enhances the image quality of the image light beam produced by the light valve, the need to increase the length of the light uniformizing unit is also eliminated.

In addition, by further including an actuating unit that is operable to drive movement of the reflecting unit relative to the diffusing member for causing reciprocating movement of the laser beams that are reflected by the reflecting surfaces of the reflecting unit and that are incident upon the diffusing member at a predetermined frequency, coherence inherent in the laser beams is destroyed, thereby preventing the formation of speckles on the light valve that adversely affect the image quality of the image light beam produced by the light valve.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional image projection apparatus;

FIG. 2 is a schematic diagram of an image projection apparatus according to a first preferred embodiment of the present invention;

FIG. 3 is a fragmentary schematic diagram, illustrating a laser array, a reflecting unit and a diffusing member according to the first preferred embodiment;

FIG. 4 is a fragmentary schematic diagram, illustrating a laser array, a reflecting unit and a diffusing member according to a second preferred embodiment of the present invention;

FIG. 5 is a fragmentary schematic diagram, illustrating a laser array, a reflecting unit and a diffusing member according to a third preferred embodiment; and

FIG. 6 is a schematic diagram of a light source module of an image projection apparatus according to a fourth preferred embodiment of the present invention.

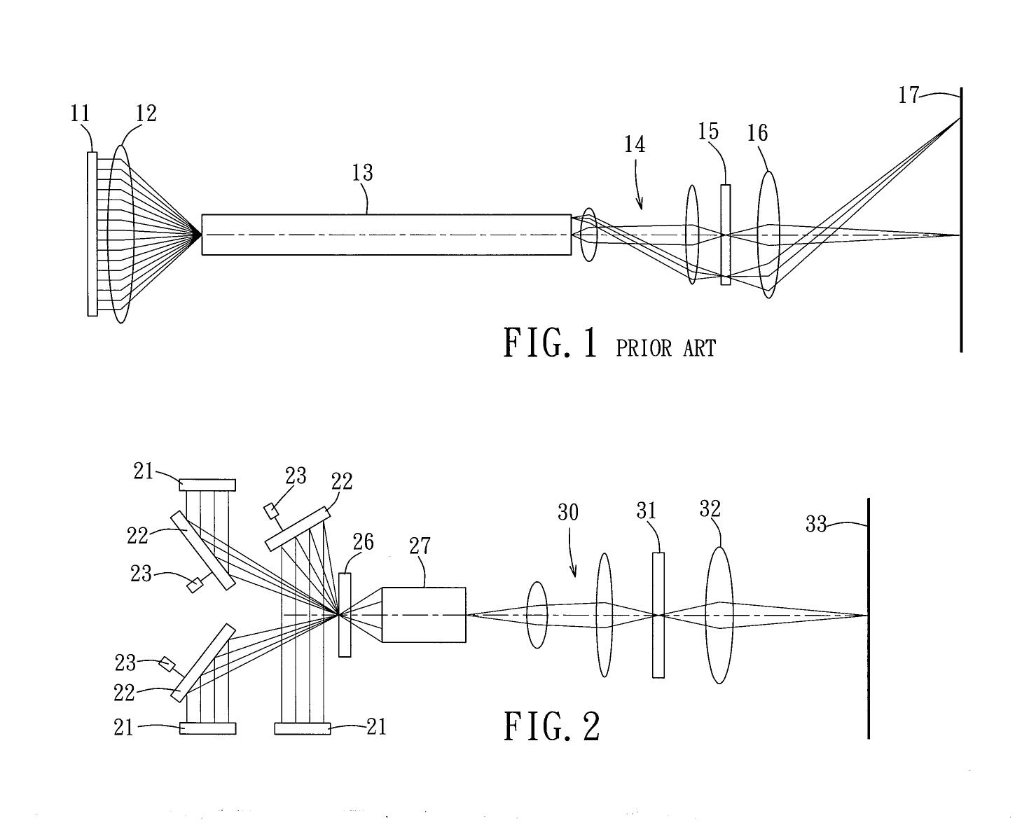

### DETAILED DESCRIPTION OF THE PREFERRED EMBODIMENTS

In the following detailed description of the preferred embodiments, reference is made to the accompanying drawings which form a part hereof, and in which there are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component faces “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

Before the present invention is described in greater detail, it should be noted that similar elements are denoted by the same reference numerals throughout the disclosure.

As shown in FIG. 2, an image projection apparatus according to a first preferred embodiment of the present invention includes at least one laser array 21, at least one reflecting unit 22, a diffusing member 26, a light uniformizing unit 27, a lens unit 30, a light valve 31, and a projection lens 32. The laser array 21, the reflecting unit 22, the diffusing member 26, and the light uniformizing unit 27 cooperate to form a light source module of the image projection apparatus.

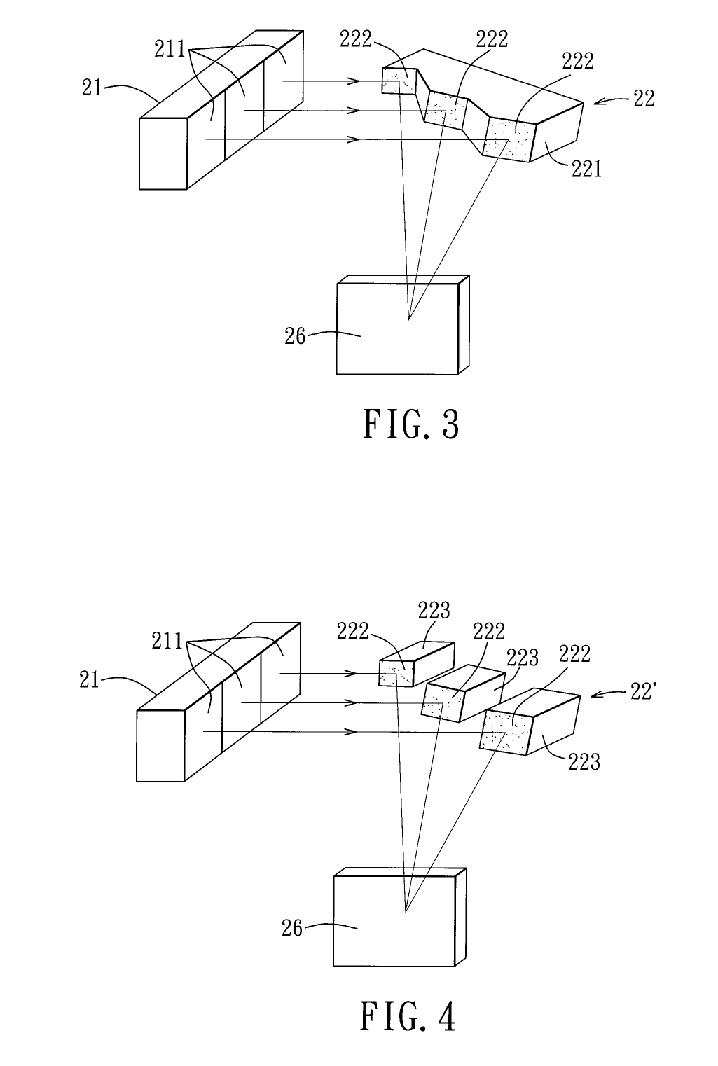

In this embodiment, the image projection apparatus includes three laser arrays 21 and three reflecting units 22. Each of the reflecting units 22 corresponds to a respective one of the laser arrays 21. One of the laser arrays 21 and the corresponding one of the reflecting units 22 are illustrated in FIG. 3 to facilitate the following description. The laser arrays 21 are identical to each other in structure. However, laser beams provided by each of the laser arrays 21 are different in color from the other two of the laser arrays 21. In this embodiment, the laser arrays 21 provide red, green and blue laser beams, respectively.

Referring to FIG. 3, each of the laser arrays 21 includes a plurality of laser units 211 that are arranged in a matrix. Each of the laser units 211 emits a coherent laser beam. The laser beams emitted from the laser units 211 of the same laser array 21 to the reflecting units 22 are parallel to each other. In this embodiment, three laser units 211 are included in each of the laser arrays 21, and are arranged in a 1×3 matrix. In addition, each of the laser units 211 is a laser diode. The laser beams emitted by the laser units 211 of each of the laser arrays 21 are different in color from those emitted by the laser units 211 of the other ones of the laser arrays 21.

Each of the reflecting units 22 has a plurality of reflecting surfaces 222 that are non-parallel to each other, and that are disposed to receive and reflect the laser beams emitted by the laser units 211 of the corresponding one of the laser arrays 21. Each of the reflecting surfaces 222 reflects the laser beams emitted by a corresponding one of the laser units 211 in a distinct direction, such that the laser beams reflected by the reflecting surfaces 222 are incident on the diffusing member 26 at a location of convergence.

According to the first preferred embodiment, each of the reflecting units 22 includes a main body 221, and the reflecting surfaces 222 are spaced at intervals and are formed on one side of the main body 221 facing the laser arrays 21.

Another implementation of the reflecting units 22′ according to a second preferred embodiment of the present invention is shown in FIG. 4. In this embodiment, three laser units 211 are included in each of the laser arrays 21, and are arranged in a 1×3 matrix. Each of the laser units 211 emits a coherent laser beam, and the laser beams emitted from the laser units 211 of the same laser array 21 to the reflecting units 22′ are parallel to each other.

Each of the reflecting units 22′ includes a plurality of main bodies 223 that are spaced apart from each other. Three main bodies 223 are included in this embodiment for illustration purposes. Each of the reflecting surfaces 222 is formed on one side of a corresponding one of the main bodies 223 facing the laser arrays 21. The reflecting surfaces 222 are non-parallel to each other, and are disposed to receive and reflect the laser beams emitted by the laser units 211 of the corresponding one of the laser arrays 21 in distinct directions.

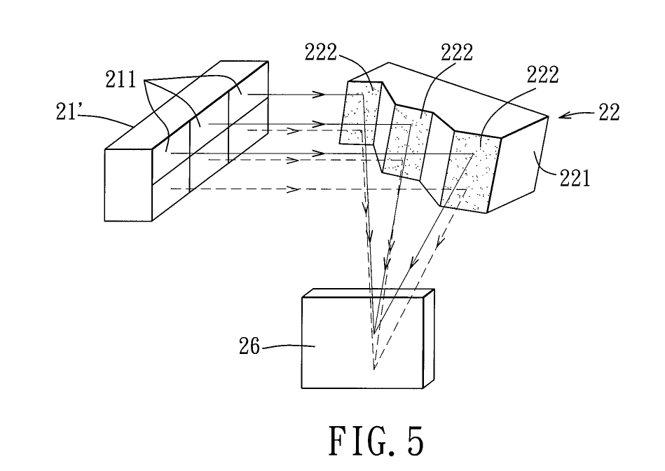

Alternatively, as shown in FIG. 5, according to a third preferred embodiment of the present invention, six laser units 211 are included in each laser array 21′, and are arranged in a 2×3 matrix. Each of the laser units 211 emits a coherent laser beam, and the laser beams emitted from the laser units 211 of the same laser array 21′ to the reflecting units 22 are parallel to each other.

Each of the reflecting units 22 has a plurality of reflecting surfaces 222 that are non-parallel to each other, and that are disposed to receive and reflect the laser beams emitted by the laser units 211 of the corresponding one of the laser arrays 21′. The reflecting surfaces 222 reflect the laser beams emitted by corresponding ones of the laser units 211 in distinct directions, such that the laser beams reflected by the reflecting surfaces 222 are incident on the diffusing member 26 at a location of convergence.

It should be noted herein that the 2×3 matrix can be divided into three columns, each including two of the laser units 211 that are arranged in a vertical direction. The laser beams emitted by the laser units 211 of each of the columns and reflected by the corresponding reflecting surface 222 are incident on the diffusing member 26 at two different points of convergence. It is only necessary to ensure that the two points be close together and fall within a relatively small area.

Referring back to FIG. 2, the image projection apparatus further includes at least one actuating unit 23. In this embodiment, the image projection apparatus includes three actuating units 23, each of which is operable to drive movement of a corresponding one of the reflecting units 22 relative to the diffusing member 26 for causing reciprocating movement of the laser beams that are reflected by the reflecting surfaces 222 (refer to FIG. 3) of the corresponding one of the reflecting units 22 and that are incident upon the diffusing member 26. The reciprocating movement of the laser beams is one of reciprocating vibration, rotation and oscillation. Preferably, the reciprocating movement of the laser beams has a frequency of higher than 40 Hz. According to the first and third preferred embodiments, each of the actuating units 23 includes a motor (not shown) that is coupled to the main body 221 (refer to FIG. 3 and FIG. 5) of the corresponding one of the reflecting units 22. According to the second preferred embodiment, each of the actuating units 23 includes a plurality of motors (not shown), each of which is coupled to a corresponding one of the main bodies 223 (refer to FIG. 4) of the corresponding one of the reflecting units 22′.

With reference to FIG. 2 and FIG. 3, the diffusing member 26 is disposed to receive and diffuse the laser beams reflected from the reflecting surfaces 222 of the reflecting units 22 so as to form an illumination beam. Preferably, the diffusing member 26 is disposed at a location of convergence of the laser beams reflected from the reflecting surfaces 222. The diffusing member 26 may be a diffusing plate, such as a ground glass, where the reflected laser beams are diffused by the diffusing member 26 into the illumination beam after traveling therethrough. Moreover, the diffusing member 26 may also be an optical element, such as a holographic optical element (HOE), a diffraction optical element (DOE), and a concave lens.

As shown in FIG. 2, the light uniformizing unit 27 is disposed to receive and uniformize the illumination beam from the diffusing member 26. The illumination beam is uniformized by the light uniformizing unit 27 after undergoing multiple reflections therein. As a result, the uniformized illumination beam from the light uniformizing unit 27 has a uniform intensity distribution. The light uniformizing unit 27 may be a solid integration rod or a hollow integration rod, but is not limited thereto in other embodiments of the present invention.

The lens unit 30 is disposed to receive the uniformized illumination beam from the light uniformizing unit 27 for adjusting a cross-sectional area of the uniformized illumination beam. The light valve 31 is disposed to receive and modulate the adjusted and uniformized illumination beam from the lens unit 30 so as to form an image light beam. The projection lens 32 is disposed to project the image light beam from the light valve 31 onto a screen 33 so as to form an image (not shown). In this embodiment, the lens unit 30 is disposed between the light uniformizing unit 27 and the light valve 31. The lens unit 30 includes a pair of lenses that are different from each other in focal length for adjusting the cross-sectional area of the uniformized illumination beam. The light valve 31 may be a transmissive liquid crystal display (LCD) or a reflective liquid crystal device (e.g., a digital light processor (DLP) and a liquid crystal on silicon (LCOS)).

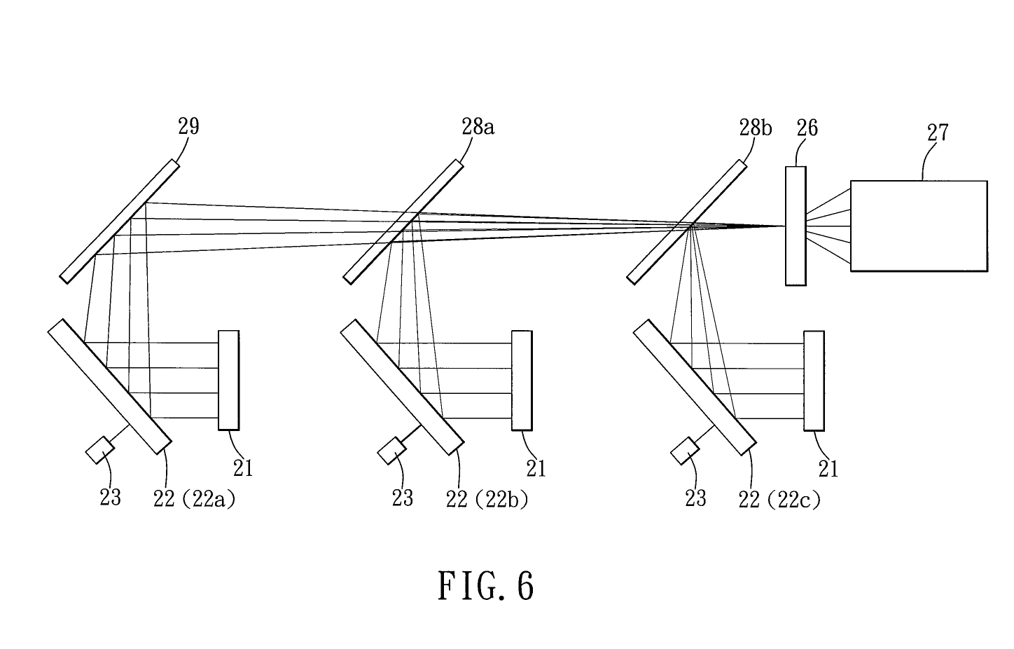

According to the fourth preferred embodiment of the present invention, the image projection apparatus may be arranged as illustrated in FIG. 6, where the image projection apparatus further includes a reflector 29 and two dichroic mirrors 28a, 28b as a part of the light source module of the image projection apparatus. The reflector 29 and the dichroic mirrors 28a, 28b are disposed to transmit the laser beams from the reflecting surfaces 222 of the reflecting units 22 to the diffusing member 26. In this embodiment, the reflector 29 reflects the laser beams reflected by a corresponding one of the reflecting units 22 (i.e., reflecting unit 22a) towards the diffusing member 26. The dichroic mirror 28a permits transmission of the laser beams reflected by the reflecting unit 22a therethrough towards the diffusing member 26, and reflects the laser beams reflected by a corresponding one of the reflecting units 22 (i.e., reflecting unit 22b) towards the diffusing member 26. The dichroic mirror 28b permits transmission of the laser beams traveling through or reflected by the dichroic mirror 28a therethrough, and reflects the laser beams reflected by a corresponding one of the reflecting units 22 (i.e., reflecting unit 22c) towards the diffusing member 26. With the presence of the reflector 29 and the dichroic mirrors 28a, 28b, overall size of the image projection apparatus is reduced.

In sum, by diffusing the laser beams reflected by the reflecting surfaces 222 of the reflecting units 22, 22′ to form the illumination beam prior to entering the light uniformizing unit 27, it is ensured that the uniformized illumination beam exiting the light uniformizing unit 27 has a uniform intensity distribution. This not only enhances the image quality of the image light beam produced by the light valve 31, the need to increase the length of the light uniformizing unit 27 (e.g., an integration rod) is also eliminated.

In addition, by further including the actuating units 23 that are operable to drive movement of the reflecting units 22 relative to the diffusing member 26 for causing reciprocating movement of the laser beams that are reflected by the reflecting surfaces 222 of the reflecting units 22 and that are incident upon the diffusing member 26 at a predetermined frequency, coherence inherent in the laser beams is destroyed, thereby preventing the formation of speckles on the light valve 31 that adversely affect the image quality of the image light beam produced by the light valve 31.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the terms “the invention”, “the present invention” or the like do not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element or component in the present disclosure is intended to be dedicated to the public regardless of whether the element or component is explicitly recited in the following claims.

What is claimed is:

1. An image projection apparatus comprising:
at least one laser array including a plurality of laser units that are arranged in a matrix, each of said laser units emitting a laser beam;
at least one reflecting unit having a plurality of reflecting surfaces that are non-parallel to each other, and that are disposed to receive and reflect the laser beams emitted by said laser units;
a diffusing member disposed to receive and diffuse the laser beams reflected from said reflecting surfaces of said at least one reflecting unit so as to form an illumination beam;
a light uniformizing unit disposed to receive and uniformize the illumination beam from said diffusing member;
a lens unit disposed to receive the illumination beam from said light uniformizing unit for adjusting a cross-sectional area of the illumination beam;
a light valve disposed to receive and modulate the illumination beam from said lens unit so as to form an image beam; and
a projection lens disposed to project the image beam from said light valve onto a screen so as to form an image.

2. The image projection apparatus as claimed in claim 1, wherein said at least one laser array includes three laser arrays.

3. The image projection apparatus as claimed in claim 1, wherein the laser beams emitted from said laser units to said reflecting unit are parallel to each other.

4. The image projection apparatus as claimed in claim 1, wherein said reflecting unit includes a main body, and said reflecting surfaces are spaced at intervals and are formed on one side of said main body facing said laser array.

5. The image projection apparatus as claimed in claim 4, further comprising an actuating unit operable to drive movement of said reflecting unit relative to said diffusing member for causing reciprocating movement of the laser beams that are reflected by said reflecting surfaces of said reflecting unit and that are incident upon said diffusing member.

6. The image projection apparatus as claimed in claim 5, wherein said actuating unit includes a motor that is coupled to said main body of said reflecting unit.

7. The image projection apparatus as claimed in claim 5, wherein the reciprocating movement of the laser beams is one of reciprocating vibration, rotation and oscillation.

8. The image projection apparatus as claimed in claim 5, wherein the reciprocating movement of the laser beams has a frequency of higher than 40 Hz.

9. The image projection apparatus as claimed in claim 1, wherein said reflecting unit includes a plurality of main bodies that are spaced apart from each other, each of said reflecting surfaces being formed on one side of a corresponding one of said main bodies facing said laser array.

10. The image projection apparatus as claimed in claim 9, further comprising an actuating unit operable to drive movement of said reflecting unit relative to said diffusing member for causing reciprocating movement of the laser beams that are reflected by said reflecting surfaces of said reflecting unit and that are incident upon said diffusing member.

11. The image projection apparatus as claimed in claim 10, wherein said actuating unit includes a plurality of motors, each of said motors being coupled to a corresponding one of said main bodies of said reflecting unit.

12. The image projection apparatus as claimed in claim 10, wherein the reciprocating movement of the laser beams has a frequency of higher than 40 Hz.

13. The image projection apparatus as claimed in claim 1, wherein said diffusing member is disposed at a location of convergence of the laser beams reflected from said reflecting surfaces, and the laser beams being diffused by said diffusing member into the illumination beam after traveling therethrough.

14. The image projection apparatus as claimed in claim 13, wherein said diffusing member is one of a ground glass, a holographic optical element (HOE) and a diffraction optical element (DOE).

15. The image projection apparatus as claimed in claim 1, wherein said at least one laser array includes two laser arrays, said at least one reflecting unit including two reflecting units, the laser beams emitted by said laser units of one of said laser arrays being different in color from those emitted by said laser units of the other one of said laser arrays, said image projection apparatus further comprising at least one dichroic mirror disposed to transmit the laser beams from said reflecting surfaces of said reflecting units to said diffusing member.

16. A light source module adapted for use in an image projection apparatus, comprising:
at least one laser array including a plurality of laser units that are arranged in a matrix, each of said laser units emitting a laser beam;
at least one reflecting unit having a plurality of reflecting surfaces that are non-parallel to each other, and that are disposed to receive and reflect the laser beams emitted by said laser units;
a diffusing member disposed to receive and diffuse the laser beams reflected from said reflecting surfaces of said at least one reflecting unit so as to form an illumination beam; and
a light uniformizing unit disposed to receive and uniformize the illumination beam from said diffusing member.

17. The light source module as claimed in claim 16, wherein the laser beams emitted from said laser units to said reflecting unit are parallel to each other.

18. The light source module as claimed in claim 16, wherein said reflecting unit includes a main body, and said reflecting surfaces are spaced at intervals and are formed on one side of said main body facing said laser array.

19. The light source module as claimed in claim 18, further comprising an actuating unit operable to drive movement of said reflecting unit relative to said diffusing member for causing reciprocating movement of the laser beams that are reflected by said reflecting surfaces of said reflecting unit and that are incident upon said diffusing member.

20. The light source module claimed in claim 16, wherein said reflecting unit includes a plurality of main bodies that are spaced apart from each other, each of said reflecting surfaces being formed on one side of a corresponding one of said main bodies facing said laser array.

21. The light source module as claimed in claim 16, wherein said diffusing member is disposed at a location of convergence of the laser beams reflected from said reflecting surfaces, and the laser beams are diffused by said diffusing member into the illumination beam after traveling therethrough.

22. The light source module as claimed in claim 16, wherein said at least one laser array includes two laser arrays, said at least one reflecting unit including two reflecting units, the laser beams emitted by said laser units of one of said laser arrays being different in color from those emitted by said laser units of the other one of said laser arrays, said image projection apparatus further comprising at least one dichroic mirror disposed to transmit the laser beams from said reflecting surfaces of said reflecting units to said diffusing member.
